(19) United States
(12) Patent Application Publication
(10) Pub. No.: US 2010/0153371 A1
(43) Pub. Date: Jun. 17, 2010

(54) METHOD AND APPARATUS FOR BLENDING SEARCH RESULTS

(75) Inventor: Vikash Singh, San Jose, CA (US)

Correspondence Address: HICKMAN PALERMO TRUONG & BECKER LLP/Yahoo! Inc., 2055 Gateway Place, Suite 550, San Jose, CA, 95110-1083, US

(73) Assignee: YAHOO! INC., Sunnyvale, CA (US)

(21) Appl. No.: 12/335,666

(22) Filed: Dec. 16, 2008

(51) Int. Cl. G06F 7/06; G06F 17/30; G06N 5/02

(52) U.S. Cl. 707/722; 706/46; 707/E17.017; 707/E17.044; 707/E17.108

(57) ABSTRACT

A system and method is provided that permits a conventional search function to use information from a social bookmarking system to provide search results, as the results from social bookmarking systems are generally very relevant. According to one example, a blended search result is determined using results from a conventional search engine and results found by a social bookmarking system. In one example, these results are blended and presented to a user within a single interface. In another example, search results and results from a social bookmarking system are normalized so that they can be combined within the same interface. Generally, a method is provided for blending search results from two or more different corpora having different search engines.

### FIELD OF THE INVENTION

The present invention relates generally to searching, and more specifically, to providing search results over the Internet.

### DISCUSSION OF RELATED ART

There are a variety of online tools and techniques for providing search results. One such tool, which resides within the context of the Internet, is the search engine. Conventional Internet search engines, such as the YAHOO! brand search engine, typically provide search results in response to queries that are submitted to the search engine by a user. There are many types of search engines that are available to provide a list of content associated with a query, such as, for example, the Google search engine, the Ask.com search engine, MSN search, among others.

More specifically, conventional Internet search engines allow users to search for content such as web pages, files, documents and other forms of information by submitting textual queries including one or more keywords. Normally, search engines parse submitted queries and find result documents that prominently feature the keywords included in the query. Search engines then present results to the user for review and selection within a user interface. Results are typically ranked by order of their relevance to the original query, and there can be a number of factors measured within the search results that may cause them to be returned in different orders.

### SUMMARY OF THE INVENTION

With the advent of Internet search and the difficulty in locating relevant information, there are computer systems that have become commonplace that permit users to identify and share relevant content located on the Internet. In particular, there are a number of systems that permit a user to associate content with classification data. One form of classifying information includes what is referred to the art as a “tag.” Tagging content is useful for many reasons. For instance, a user may construct their own organizational structures (e.g., tags, directories, folders, etc.) for organizing information. Such information may be, for example, file information in a file system, application data accessible in an application, or any other information that is suitable to be organized or classified. By organizing data, such data may more quickly located by users.

Recently, systems have become commonplace for permitting users to share classification information. One such system includes what is referred to as a social bookmarking system. In such a system, multiple users associate classifications (e.g., “tag” information) with resources available in a distributed computing network. The classification information may be, for example, in the form of one or more “tags” associated with content such as that available through the Internet. These tags each may include a single-word keyword defined by a user to describe referenced content, although it should be appreciated that some tags may have a variety of formats and include a variety of information.

Social bookmarking systems are typically used to organize references to content (e.g. URLs), and associate classification information with such references. Examples of such systems include the del.icio.us bookmarking system and Internet service, available at http://del.icio.us, the Spurl.net bookmarking system and service available at http://www.spurl.net, the dig bookmarking service available at http://www.digg.com, the StumbleUpon bookmarking service available at http://www.stumbleupon.com, among others. In such systems, a user associates words or other classification information that have specific meaning to the user so that the user may more easily organize and retrieve such information in the future. Because users classify the information, the relevancy of such classified information is generally very high, and this results in a classification that has a higher likelihood that the desired content is found. More particularly, it is appreciated that in social bookmarking, there is a “wisdom of the crowds” that determines the relevancy (or not) of particular content. For example, if many users bookmark the same content (e.g., a URL), the popularity of that content (e.g., as indicated by the number of times the content has been bookmarked by users) increases. Thus, the bookmark counts serves as a score of social authority for content.

According to one aspect of the present invention, it is realized that it may be beneficial to permit a conventional search function to use information from a social bookmarking system to provide search results, as the results from social bookmarking systems are generally very relevant. As discussed above, social bookmarking systems use “wisdom of the crowds” to determine relevant content (e.g., as reflected by bookmark count), and this social measure of relevancy is not available in conventional search engines. According to one embodiment, a blended search result is determined using results from a conventional search engine and results found by a social bookmarking system. In yet another embodiment, these results are blended and presented to a user within a single interface. In one embodiment, search results and results from a social bookmarking system are normalized so that they can be combined within the same interface. That is, it is realized that the ranking functions that determine the relevancy of each content item is different among different search functions. Thus, in order to display results in a coherent way, ranking functions between the search and social bookmarking systems are normalized to each other. In one embodiment, it is appreciated that social bookmarking ranking may produce results that are more highly relevant, so a preference (e.g., a weighting) may be given to the social bookmarking results.

According to another aspect of the present invention, it is realized that a way by which a search engine or classification engine “scores” or otherwise measures a form of content can be modeled and reproduced. For instance, it is appreciated that a scoring function of a social bookmarking system can be modeled and used to produce theoretical scores of content that are not currently tracked within the social bookmarking system. Because the performance of a particular search function may be modeled, information not within a corpus of the search function database may be classified or otherwise scored by using the search function model. In the case where a social bookmarking system is modeled, highly relevant content may be located without needing the content to be “processed” by the social bookmarking system. The model of the social bookmarking system may also be used to rank results of a search engine for the purpose of providing more relevant results.

In one embodiment, a model of a search function is “trained” using sample data provided using a number of parameters relating to the content. According to one embodiment, these parameters may be measured or otherwise derived from the content. For instance, there may be one or more link features that relate to the link, its address, the content type, and where the content is located. Other parameters may be related to the content information itself, such as how recent the content is, how “spammy” (or how similar the content is to spam) is the content, how “bloggy” (or how similar is the content to a blog) the content is, how readable the content is, what the page rank is, the quality of the webpage design, how “newslike” the webpage content is, or any other parameter that describes a characteristic of the content. A “score” for each parameter may be determined for the content, and such information may be used to determine a transfer function (or other learning model) using these parameters.

In the case of determining a social bookmarking “score,” it may be desired to determine an expected count of the number of times a particular content item would be bookmarked (if the content item indeed was being tracked by the social bookmarking system). This score may be predicted using the parameters as discussed above for a known set of content having known scores (e.g., bookmarking counts), and determining a transfer function or other model that can predict the outcome for yet unscored content. According to one aspect, it is appreciated that there may be a correlation of particular content and link parameters to behavior of a search engine or other system that processes Internet information. That is, there may be parameters that may be used to predict other behaviors of a system to particular pieces of content.

According to one embodiment, it is appreciated that there is a benefit to combining the behavior of a social networking application with a search engine to affect the display of search results. This feature is also helpful for the social networking application, as it is appreciated that there is much content that is not being tracked by the social network system (e.g., in a bookmarking application, particular content may have zero bookmarks). Thus, a general-purpose search engine may be used to provide additional results which can be ordered (e.g., in a display presented to the user) in a similar ranking behavior as the social networking application. Further, it is also appreciated that social networking applications rank more highly over time (e.g., relevant content gets more relevant (more bookmarks) the longer it is being tracked by the social bookmarking application. However, until content is “processed” by the social networking system, the content will be indicated as having little relevance, and perhaps none at all. Results with higher link features have more time to get other sites to link to them, and thus increase their link feature values. The more links typically corresponds to higher bookmarking counts (e.g., by a social bookmarking system). By removing link features from the model, recent (yet undiscovered) results are given a chance to obtain higher relevancy scores and thus these current results may be identified and displayed in the blended output. To this end, a model based more predominantly on content rather than link features may be used according to one embodiment.

According to one embodiment, a regression model is used for modeling the search function behavior (e.g., the “count” number that corresponds to the number of times particular content is bookmarked in a social bookmarking system). However, it should be appreciated that other machine learning models may be used. For instance, classification models such as support vector machines (SVMs) may be used to train and learn the behavior of the search engine. Such a model may be trained on a training set of content items, having particular parameters (e.g., recency, bloggyiness, how newslike, etc.) and values, and then the model may be used in real-time can predict how many bookmarks (or how interesting particular content might be) in the context of a social bookmarking system.

In another embodiment of the present invention, it is appreciated that generally, methods are provided herein for blending search results from two different corpora normally accessed through two (or more) different search engines (e.g., conventional, social bookmarking, and/or other vertical search engines, in any combination). Although it is beneficial to combine social-type search behavior (e.g., as provided by a social bookmarking system) with different behavior of a different type of search engine, it should be appreciated that any types of behavior of any type of search engine can be combined with any other type using techniques described herein. Further, according to one embodiment, such combination of behavior may be performed without modifying the behaviors (or having access to) the underlying search engines. Because of this, a combination of search engine results can be performed at query time without the need for additional indices or the need to merge and build a custom index for the blended search product.

According to one aspect, a computer-implemented method for searching information is provided, the method comprising acts of providing for an interface to accept a query to search one or more database entries, performing, by a search engine, the query on the one or more database entries, and retrieving a plurality of results, the plurality of results including at least two result entries. The method further comprises acts of providing a model of a social networking ranking function, determining a social networking ranking of the at least two result entries using the model of the social networking ranking function, performing, by a social networking system search engine, the query on a social networking database, and retrieving at least one result, the at least one result including an associated social networking ranking, and presenting, in order of social networking ranking, the at least two result entries with the at least one result, within a single interface to a user.

According to one embodiment, the social networking ranking includes a bookmark score. According to another embodiment, the bookmark score indicates a number of times a particular content item was bookmarked in the social networking database. According to another embodiment, the method further comprises an act of determining a transfer function that models a ranking behavior of a social networking ranking function. According to another embodiment, the social networking ranking function produces a bookmarking score.

According to another embodiment, the method further comprises an act of indicating a preference for search results produced by the social networking system search engine. According to another embodiment, the method further comprises an act of indicating the preference by a preferred order of entries within the single interface. According to another embodiment, the method further comprises an act of providing a plurality of parameters associated with the at least two result entries to the model of the social networking ranking function.

According to another embodiment, the method further comprises an act of producing, by the model of the social networking ranking function, respective scores indicating a relevancy of the respective at least two result entries. According to another embodiment, wherein the respective scores are predicted bookmark counts of the respective at least two result entries. According to another embodiment, the plurality of parameters are determined by the search engine. According to another embodiment, the plurality of parameters are determined for content referred to by the database entries.

According to another aspect, a distributed computer system is provided that is adapted to perform a search query, the distributed computer system comprising an interface adapted to accept search criteria, a search engine adapted to produce a first set of search results based on the search criteria, and a scoring engine adapted to score the first set of search results, the scoring engine being trained to score search results based on a set of parameters. The computer system further comprises a social networking search engine adapted to perform a query based on the search criteria on a social networking database, and retrieving at least one result, the at least one result including an associated social networking ranking, and an interface adapted to present, in order of a social networking ranking, the first set of search results and the at least one result, within a single interface to a user.

According to one embodiment, the social networking ranking includes a bookmark score. According to another embodiment, the bookmark score indicates a number of times a particular content item was bookmarked in the social networking database. According to another embodiment, the computer system further comprises a component adapted to determine a transfer function that models a ranking behavior of a social networking ranking function. According to another embodiment, the social networking ranking function is adapted to produce a bookmarking score. According to another embodiment, the interface is adapted to indicate a preference for search results produced by the social networking system search engine.

According to another embodiment, the interface is adapted to indicate the preference by a preferred order of entries within the interface. According to another embodiment, the search engine is adapted to provide a plurality of parameters associated with the at least two result entries to the model of the social networking ranking function. According to another embodiment, the model of the social networking ranking function is adapted to determine respective scores indicating a relevancy of the respective at least two result entries.

According to another embodiment, the respective scores are predicted bookmark counts of the respective at least two result entries. According to another embodiment, the plurality of parameters are determined by the search engine. According to another embodiment, the plurality of parameters are determined for content referred to by the database entries.

According to another aspect, a distributed computer system is provided that is adapted to perform a search query, the distributed computer system comprising an interface adapted to accept search criteria, a first search engine adapted to produce a first set of search results based on the search criteria, the first set of search results having a first ranking, and a second search engine adapted to produce a second set of search results based on the search criteria, the second set of search results having a second ranking. The computer system further comprises a model of a ranking behavior of the second search engine, a component that normalizes the ranking behavior of the second search engine to a ranking behavior of the first search engine, a component adapted to determine a combined ranking of the first set of search results and the second set of search result, and an interface adapted to present the combined ranking to at least one of a computer system and a user. According to one embodiment, the model of the ranking behavior of the second search engine is used to determine an estimated bookmark count of content.

Further features and advantages as well as the structure and operation of various embodiments are described in detail below with reference to the accompanying drawings. In the drawings, like reference numerals indicate like or functionally similar elements. Additionally, the left-most one or two digits of a reference numeral identifies the drawing in which the reference numeral first appears.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates an example computer system upon which various aspects in accord with the present invention may be implemented;

FIG. 2 depicts an example search engine in the context of a distributed system according to an embodiment;

FIG. 3 shows an example physical and logical diagram of a search engine according to an embodiment;

FIG. 4 illustrates an example process for providing search results to a user according to an embodiment;

FIG. 5 depicts an example process for modeling a search function according to an embodiment;

FIG. 6 shows an example training database according to an embodiment;

FIG. 7 is an example interface that shows blended results;

FIG. 8 shows a general purpose computer system suitable for implementing various aspects of the present invention;

FIG. 9 shows a storage device suitable for use with aspects of the present invention; and

FIG. 10 shows a communication network upon which various aspects may be implemented.

### DETAILED DESCRIPTION

The aspects disclosed herein, which are in accord with the present invention, are not limited in their application to the details of construction and the arrangement of components set forth in the following description or illustrated in the drawings. These aspects are capable of assuming other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

For example, according to various embodiments of the present invention, a computer system is configured to perform any of the functions described herein, including but not limited to, ranking the relevancy of content and providing blended results from a plurality of search functions. However, such a system may also perform other functions. Moreover, the systems described herein may be configured to include or exclude any of the functions discussed herein. Thus the invention is not limited to a specific function or set of functions. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items.

### Computer System

Various aspects and functions described herein in accord with the present invention may be implemented as hardware or software on one or more computer systems. There are many examples of computer systems currently in use. Some examples include, among others, network appliances, personal computers, workstations, mainframes, networked clients, servers, media servers, application servers, database servers and web servers. Other examples of computer systems may include mobile computing devices, such as cellular phones and personal digital assistants, and network equipment, such as load balancers, routers and switches. Additionally, aspects in accord with the present invention may be located on a single computer system or may be distributed among a plurality of computer systems connected to one or more communication networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Thus, the invention is not limited to executing on any particular system or group of systems. Further, aspects may be implemented in software, hardware or firmware, or any combination thereof. Thus, aspects in accord with the present invention may be implemented within methods, acts, systems, system elements and components using a variety of hardware and software configurations, and the invention is not limited to any particular distributed architecture, network, or communication protocol.

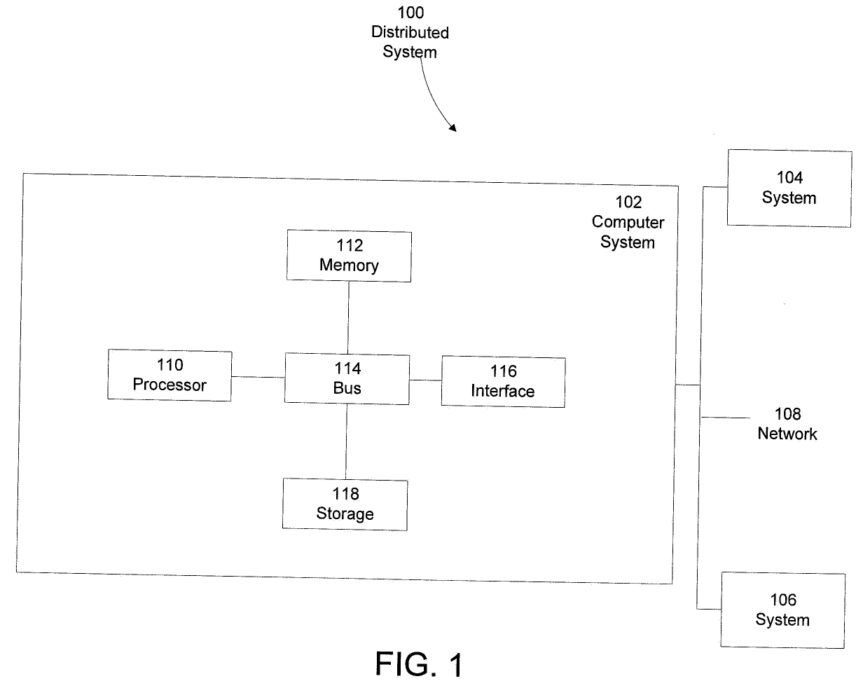

FIG. 1 shows a block diagram of a distributed computer system 100, in which various aspects and functions in accord with the present invention may be practiced. The distributed computer system 100 may include one more computer systems. For example, as illustrated, the distributed computer system 100 includes three computer systems 102, 104 and 106. As shown, the computer systems 102, 104 and 106 are interconnected by, and may exchange data through, a communication network 108. The network 108 may include any communication network through which computer systems may exchange data. To exchange data via the network 108, the computer systems 102, 104 and 106 and the network 108 may use various methods, protocols and standards including, among others, token ring, Ethernet, Wireless Ethernet, Bluetooth, TCP/IP, UDP, HTTP, FTP, SNMP, SMS, MMS, SS7, JSON, XML, REST, SOAP, CORBA IIOP, RMI, DCOM and Web Services. To ensure data transfer is secure, the computer systems 102, 104 and 106 may transmit data via the network 108 using a variety of security measures including TSL, SSL or VPN, among other security techniques. While the distributed computer system 100 illustrates three networked computer systems, the distributed computer system 100 may include any number of computer systems, networked using any medium and communication protocol.

Various aspects and functions in accord with the present invention may be implemented as specialized hardware or software executing in one or more computer systems including a computer system 102 shown in FIG. 1. As depicted, the computer system 102 includes a processor 110, a memory 112, a bus 114, an interface 116 and a storage system 118. The processor 110, which may include one or more microprocessors or other types of controllers, can perform a series of instructions that result in manipulated data. The processor 110 may be a commercially available processor such as an Intel Pentium, Motorola PowerPC, SGI MIPS, Sun UltraSPARC, or Hewlett-Packard PA-RISC processor, but may be any type of processor or controller as many other processors and controllers are available. As shown, the processor 110 is connected to other system elements, including a memory 112, by the bus 114.

The memory 112 may be used for storing programs and data during operation of the computer system 102. Thus, the memory 112 may be a relatively high performance, volatile, random access memory such as a dynamic random access memory (DRAM) or static memory (SRAM). However, the memory 112 may include any device for storing data, such as a disk drive or other non-volatile storage device. Various embodiments in accord with the present invention can organize the memory 112 into particularized and, in some cases, unique structures to perform the aspects and functions disclosed herein.

Components of the computer system 102 may be coupled by an interconnection element such as the bus 114. The bus 114 may include one or more physical busses (for example, busses between components that are integrated within a same machine), but may include any communication coupling between system elements including specialized or standard computing bus technologies such as IDE, SCSI, PCI and InfiniBand. Thus, the bus 114 enables communications (for example, data and instructions) to be exchanged between system components of the computer system 102.

The computer system 102 also includes one or more interface devices 116 such as input devices, output devices and combination input/output devices. The interface devices 116 may receive input or provide output. More particularly, output devices may render information for external presentation. Input devices may accept information from external sources. Examples of interface devices include, among others, keyboards, mouse devices, trackballs, microphones, touch screens, printing devices, display screens, speakers, network interface cards, etc. The interface devices 116 allow the computer system 102 to exchange information and communicate with external entities, such as users and other systems.

The storage system 118 may include a computer readable and writeable nonvolatile storage medium in which instructions are stored that define a program to be executed by the processor. The storage system 118 also may include information that is recorded, on or in, the medium, and this information may be processed by the program. More specifically, the information may be stored in one or more data structures specifically configured to conserve storage space or increase data exchange performance. The instructions may be persistently stored as encoded signals, and the instructions may cause a processor to perform any of the functions described herein. The medium may, for example, be optical disk, magnetic disk or flash memory, among others. In operation, the processor 110 or some other controller may cause data to be read from the nonvolatile recording medium into another memory, such as the memory 112, that allows for faster access to the information by the processor than does the storage medium included in the storage system 118. The memory may be located in the storage system 118 or in the memory 112. The processor 110 may manipulate the data within the memory 112, and then copy the data to the medium associated with the storage system 118 after processing is completed. A variety of components may manage data movement between the medium and integrated circuit memory element and the invention is not limited thereto. Further, the invention is not limited to a particular memory system or storage system.

Although the computer system 102 is shown by way of example as one type of computer system upon which various aspects and functions in accord with the present invention may be practiced, aspects of the invention are not limited to being implemented on the computer system as shown in FIG. 1. Various aspects and functions in accord with the present invention may be practiced on one or more computers having a different architectures or components than that shown in FIG. 1. For instance, the computer system 102 may include specially-programmed, special-purpose hardware, such as for example, an application-specific integrated circuit (ASIC) tailored to perform a particular operation disclosed herein. While another embodiment may perform the same function using several general-purpose computing devices running MAC OS System X with Motorola PowerPC processors and several specialized computing devices running proprietary hardware and operating systems.

The computer system 102 may include an operating system that manages at least a portion of the hardware elements included in computer system 102. A processor or controller, such as processor 110, may execute an operating system which may be, among others, a Windows-based operating system (for example, Windows NT, Windows 2000 (Windows ME), Windows XP, or Windows Vista) available from the Microsoft Corporation, a MAC OS System X operating system available from Apple Computer, one of many Linux-based operating system distributions (for example, the Enterprise Linux operating system available from Red Hat Inc.), a Solaris operating system available from Sun Microsystems, or a UNIX operating systems available from various sources. Many other operating systems may be used, and embodiments are not limited to any particular operating system.

The processor and operating system together define a computing platform for which application programs in high-level programming languages may be written. These component applications may be executable, intermediate (for example, C# or JAVA bytecode) or interpreted code which communicate over a communication network (for example, the Internet) using a communication protocol (for example, TCP/IP). Similarly, aspects in accord with the present invention may be implemented using an object-oriented programming language, such as SmallTalk, JAVA, C++, Ada, or C# (C-Sharp). Other object-oriented programming languages may also be used. Alternatively, procedural, scripting, or logical programming languages may be used.

Additionally, various aspects and functions in accord with the present invention may be implemented in a non-programmed environment (for example, documents created in HTML, XML or other format that, when viewed in a window of a browser program, render aspects of a graphical-user interface or perform other functions). Further, various embodiments in accord with the present invention may be implemented as programmed or non-programmed elements, or any combination thereof. For example, a web page may be implemented using HTML while a data object called from within the web page may be written in C++. Thus, the invention is not limited to a specific programming language and any suitable programming language could also be used.

A computer system included within an embodiment may perform functions outside the scope of the invention. For instance, aspects of the system may be implemented using an existing commercial product, such as, for example, Database Management Systems such as SQL Server available from Microsoft of Seattle Wash., Oracle Database from Oracle of Redwood Shores, Calif., and MySQL from Sun Microsystems of Santa Clara, Calif. or integration software such as WebSphere middleware from IBM of Armonk, N.Y. However, a computer system running, for example, SQL Server may be able to support both aspects in accord with the present invention and databases for sundry applications not within the scope of the invention.

### Example System Architecture

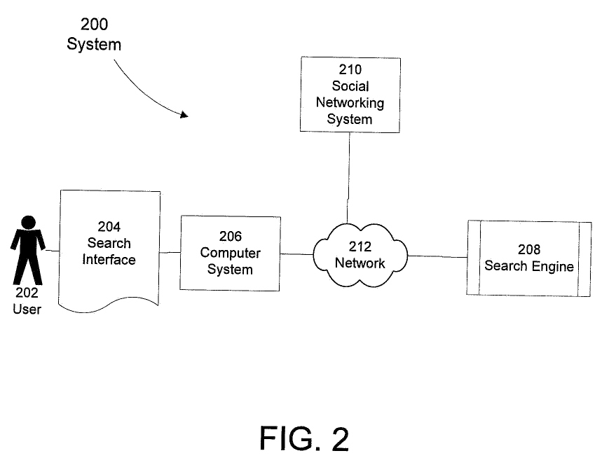

FIG. 2 presents a context diagram of a distributed system 200 specially configured to include an embodiment in accordance with various aspects of the present invention. Referring to FIG. 2, the system 200 includes a user 202, a search interface 204, a computer system 206, a search engine 208, a social networking system 210, and a communications network 212. As discussed above, behavior of a search engine (e.g., engine 208) may be combined with the behavior of a social bookmarking system (e.g., system 210). However, it should be appreciated that, according to various embodiments of the present invention, the behaviors of any type and number of search engines and/or social networking systems may be combined.

In the embodiment shown, the search interface 204 is a browser-based user interface served by the search engine 208 and rendered by the computer system 206. In this illustration, the computer system 206, the search engine 208, and the social networking system 210 are interconnected via the network 212. The network 212 may include any communication network through which member computer systems may exchange data. For example, the network 212 may be a public network, such as the Internet, and may include other public or private networks such as LANs, WANs, extranets and intranets.

The sundry computer systems shown in FIG. 2, which include the computer system 206, the search engine 208, the social networking system 210, and the network 212 each may include one or more computer systems. As discussed above with regard to FIG. 1, computer systems may have one or more processors or controllers, memory and interface devices. The particular configuration of system 200 depicted in FIG. 2 is used for illustration purposes only and embodiments of the invention may be practiced in other contexts. Thus, the invention is not limited to a specific number of users or systems.

In various embodiments, the search engine 208 includes facilities configured to provide search results to users. In the illustrated embodiment, the search engine 208 can provide the search interface 204 to the user 202. The search interface 204 may include facilities configured to allow the user 202 to search, select and review a variety of content. For example, in one embodiment, the search interface 204 can provide, within a set of search results, navigable links to documents available from a wide variety of websites connected to the network 212. In other embodiments, the search interface 204 can provide links to documents stored in the search engine 208.

In another embodiment, the search engine 208 includes facilities configured to rank search results according to a function learned through previous ranking behavior of social networking system 210 (or any other vertical search system). According to one embodiment, search engine 208 may use a transfer function or other learning machine to rank and/or classify a plurality of search results returned by search engine 208 in response to a query. For instance, the query may include a plurality of keywords entered by a user within search interface 204.

According to another embodiment, the search interface 204 also includes facilities configured to present additional content in association with document or other content links included in search results. The additional content may be any information conveyable via a computer system that is representative of the subject of the linked content. For example, in one embodiment, the search interface 204 can provide images, or other content, that portray the subject of one or more linked content returned by the search engine 208.

In various embodiments, the search engine 208 may perform search functions on behalf of a social networking system (e.g., system 210) or other system, and may provide results which can be ranked and presented in an interface of the other system (e.g., in an interface of a social networking system). In either case, a single interface may be provided that blends results of the search engine 208 and any other system (e.g., social networking system 210 or any other search engine). As discussed, regular search engines results produced by a search engine 208 may be combined with results produced by a social bookmarking system or any other type of vertical search function.

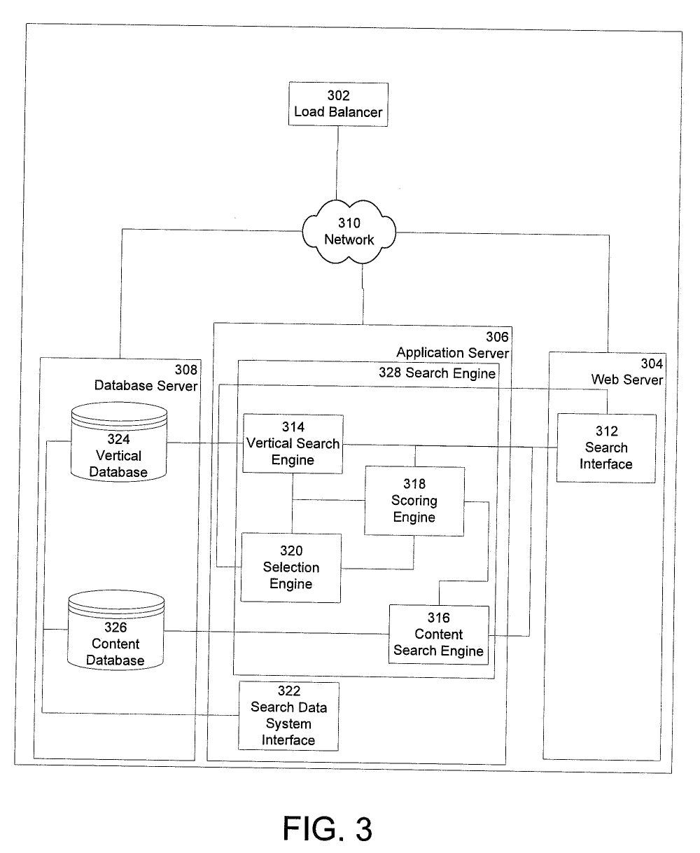

FIG. 3 provides a more detailed illustration of a particular physical and logical configuration of a search engine 208 as a distributed system. The system structure and content discussed below are for exemplary purposes only and are not intended to limit the invention to the specific structure shown in FIG. 3. As will be apparent to one of ordinary skill in the art, many variant system structures can be architected without deviating from the scope of the present invention. The particular arrangement presented in FIG. 3 may include more or less components and is presented by way of example and not limitation.

In the embodiment illustrated in FIG. 3, search engine 208 includes a number of physical or logical elements: a load balancer 302, a web server 304, an application server 306, a database server 308 and a network 310. Each of these physical elements may include one or more computer systems as discussed with reference to FIG. 1 above. Further, in the illustrated embodiment, the web server 304 includes one logical element, a search interface 312. The application server 306 includes several logical elements: a search engine 328 and a content system interface 318. The search engine 328 has facilities configured to manage the flow of information between constituent subsystems and includes a vertical search engine 314 (e.g., a search engine associated with a social bookmarking system), a content search engine 316, a scoring engine 318 and a selection engine 320. The database server 308 includes several logical elements: a vertical database 324 and a content database 326.

In the depicted embodiment, the load balancer 302 provides load balancing services to the other elements of search engine 208. The network 310 may include any communication network through which member computer systems may exchange data. The web server 304, the application server 306 and the database server 308 may be, for example, one or more computer systems as described above with regard to FIG. 1. For a high volume website, web server 304, application server 306 and database server 308 may include multiple computer systems, but embodiments may include any number of computer systems. Web server 304 may serve content using any suitable standard or protocol including, among others, HTTP, HTML, DHTML, XML and PHP.

In the embodiment illustrated in FIG. 3, the logical elements include facilities that are configured to exchange information as follows. Search interface 312 includes facilities configured to receive query information from, and provide search results to, various external entities, such as a user or an external system. Additionally, the search interface 312 can provide query information to the vertical search engine 314, the content search engine 316, the scoring engine 318 and the selection engine 320. Also, in this embodiment, the search interface 312 can receive search results from the selection engine 320.

As shown in the embodiment of FIG. 3, the vertical search engine 314 has facilities configured to receive query information from the search interface 312 and vertical information from the vertical database 324. Such vertical information may include, for example, ranking information produced by a social networking system. In one embodiment, such information may include a bookmark count associated with particular content of the content database 326. Moreover, the vertical search engine can provide content information to the scoring engine 318 and the selection engine 320. Furthermore, as depicted, the content search engine 316 has facilities configured to receive query information from the search engine 312 and content information from the content database 326. In addition, according to this embodiment, the content search engine 316 can provide content information to the scoring engine 318.

Further according to the embodiment of FIG. 3, the scoring engine 318 has facilities configured to receive query information from search interface 312, information from vertical search engine 314 and content information from the content search engine 316. As illustrated, the scoring engine 318 can provide content information, such as scored content information, to the selection engine 320. As shown, the selection engine 320 has facilities configured to receive content information from the scoring engine and vertical information from the vertical search engine 314 and to provide search results to the search interface 312. Additionally, the search data system interface 322 can receive content and document information from a variety of external entities and can provide the content information to the content database 326 and the vertical information to the document database 324.

Information may flow between the elements, components and subsystems described herein using any technique. Such techniques include, for example, passing the information over the network via TCP/IP, passing the information between modules in memory and passing the information by writing to a file, database, or some other non-volatile storage device. In addition, pointers or other references to information may be transmitted and received in place of, or in addition to, copies of the information. Conversely, the information may be exchanged in place of, or in addition to, pointers or other references to the information. Other techniques and protocols for communicating information may be used without departing from the scope of the invention.

With continued reference to the embodiment of FIG. 3, the vertical database 324 includes facilities configured to store and retrieve information. Vertical information may include any information related to content that are available for search by a user of a computer system, such as bookmark information of a social networking system. Vertical information such as bookmark information may be stored within the vertical database 324, and may be available for users to search over a network, such as the Internet. Examples of vertical information include, among others, the content referenced by the bookmark and metadata describing the content including classification information such as tags, that are selected by users to classify the content, along with the counts of the number of times a particular content item has been bookmarked.

According to the illustrated embodiment, the content database 326 includes structures configured to store and retrieve content information. Content information may include or reference any information regarding content that is conveyable via a computer system. Examples of content information include, among others, the content and metadata describing the content such as content versions, content sizes, content edit histories, available translations of the content, content storage locations, textual title or other identifiers of the content, information descriptive of the content, such as an textual abstract, and classification information, such as tags, that classify the content. In certain embodiments, the content included in the content information may be, among other information, executable content or non-executable content, such as still images, movies, audio, and text.

The databases 324 and 326 may take the form of any logical construction capable of storing information on a computer readable medium including flat files, indexed files, hierarchical databases, relational databases or object oriented databases. In addition, links, pointers, indicators and other references to data may be stored in place, of or in addition to, actual copies of the data.

With continued reference to the embodiment of FIG. 3, the search data system interface 322 has facilities configured to receive search data from a variety of external entities and to provide the search data to the document database 324 and the content database 326 for storage. For example, according to one embodiment, the search data system interface 322 can receive document information or content information from a web crawler. In this embodiment, the search data system interface 322 can provide the received information to the vertical database 324 or the content database 326, as appropriate.

In another exemplary embodiment, the search data system interface 322 can receive information from one or more automated information feeds and can provide the received information to the vertical database 324 and the content database 326 for storage. The information received from the feeds may include document information such as news articles, and additional content information that is associated with the document information. The document information may indicate that associations between the news articles and the additional content information were established by a user, such as an editor.

In other embodiments, the search data system interface 322 can receive unassociated content information. In these embodiments, the search data system interface 322 can provide the content information to the content database 326 for storage. This content information may include or reference a variety of content, such as, among other content, images of current events, images and logos of businesses and multi-media presentations for hotels, resorts and other travel destinations.

With continued reference to the embodiment of FIG. 3, the vertical search engine 314 has facilities configured to retrieve document information that matches query information. The query information may include any information related to one or more queries for information entered by an external entity (e.g., a user, system or process). For example, in one embodiment, the vertical search engine 314 can receive a set of textual keywords provided by a user through the search interface 312. The vertical information may include any information discussed above with regard to the vertical database 324. Thus, in one example, the vertical information may include references, such as hyperlinks, to content references in a social bookmarking database (e.g., as stored in vertical database 324). In another example, the vertical information may include hyperlinks to documents that are stored in an external system, such as one or more websites accessible via the Internet. In still another example, the vertical information may include information associated with the content information, e.g., tags that refer to content that is bookmarked by the social networking system. As shown in the embodiment of FIG. 3, the vertical search engine 314 can provide this vertical information to the scoring engine 318.

In some embodiments, the vertical search engine 314 includes facilities configured to search within one or more vertical search classes. In this manner, embodiments can provide searching facilities that focus on the specific groups of content defined by the vertical search classes. For example, according to an embodiment directed toward bookmarked information, the vertical search engine 314 can perform searches specifically targeting information specific to particular key words. Other embodiments focus on other vertical search classes, such as news, images, movies, video gaming, local businesses and travel.

In another embodiment, the content search engine 316 includes facilities configured to retrieve content information that may be representative of, or relevant to, the subjects of documents matching the query information. As discussed above, the query information may include a set of textual keywords provided by a user through the search interface 312. The content information may include any content information discussed above with regard to the content database 326. Thus, in one example, the content information may include content, or a reference to content, stored in the content database 326. In an additional example, the content information may include a reference to content stored in an external system, such as one or more websites accessible via the Internet. In the embodiment of FIG. 3, the content search engine 316 can provide this content information to the scoring engine 318.

Like the vertical search engine 314, in some embodiments, the content search engine 316 includes facilities configured to search within one or more vertical search classes. For example, according to an embodiment directed toward current events, the content search engine 316 can perform searches specifically targeting content related to current events. Other embodiments focus on other vertical search classes, such as images, movies, video gaming, local businesses and travel.

With continued reference to the embodiment of FIG. 3, the scoring engine 318 includes facilities configured to score the relevancy of the content information provided by the content search engine 316 and the vertical search engine 314 relative to the content matching the query information provided by the search interface 312. Various embodiments may employ a variety of functions to compute this relevancy score. Some embodiments use a heuristic or parametric function based on the query information and the content information. Other embodiments may use a statistical model based on the query information and the content information.

For example, according to one embodiment, the scoring engine 318 can use the text included in the query information, the text included in the document information, such as titles, abstracts, tags, document content, etc., and the text included in the content information, such as titles, abstracts, tags, textual content, etc. to compute the relevancy score. In this embodiment, the scoring function is configured to produce a high score when the text included in the content information matches either the query text or the text included within the content information. Thus, when dealing with large amounts of content information, the scoring function may minimize the likelihood of scoring irrelevant content highly.

In another embodiment, the scoring engine 318 includes facilities configured to use a scoring function in the form of a statistical model. In this embodiment, the scoring engine 318 can train the scoring function using machine learning techniques. For example, according to one embodiment, the scoring function can be trained to discriminate based on characteristics such as query text, text included in the document information and the content information, matches between the query text, the text included in the content information, the recency of the content, the identity of feed source or other information. In an additional embodiment, the scoring function can be trained using characteristics of the content, such as the size or duration of the content and the complexity included in the content, such as the distribution of colors in an image. Thus embodiments of the scoring engine 318 may discern content that is suitable for displays with limited resources using a wide variety of content traits.

A selection engine 320 can provide search results including content information to search interface 312. With reference to the embodiment shown in FIG. 3, the search interface 312 includes facilities configured to provide a variety of graphical user interface (GUI) metaphors designed to allow an external entity, such as a user, to search for content, navigate search results, select documents to review content. For example, in some embodiments, the search interface 312 includes GUI elements to enable a user to enter one or more textual keyword queries that are collaboratively processed with the search engine 328. In a particular embodiment, these GUI elements include a text box and a query actuation element, such as a button.

In another embodiment, the search interface 312 has facilities configured to store and provide query information to the vertical search engine 314, the content search engine 316 and the scoring engine 318. This query information may be any information related to current or previous queries entered by an external entity. Example of query information included, among others, the text of the query, previous versions of the query and an indicator of the external entity that entered the query.

In other embodiments, the search interface 312 has facilities configured to provide one or more navigable links to documents included in a set of search results to an external entity. As discussed above, the search results may include both document and content information. According to one embodiment, the search interface 312 can receive document and content information from the selection engine 320 and can provide the documents any associated content referenced in the document and content information to various external entities.

Each of the interfaces disclosed herein exchange information with various providers and consumers. These providers and consumers may include any external entity including, among other entities, users and systems. In addition, each of the interfaces disclosed herein may both restrict input to a predefined set of values and validate any information entered prior to using the information or providing the information to other components. Additionally, each of the interfaces disclosed herein may validate the identity of an external entity prior to, or during, interaction with the external entity. These functions may prevent the introduction of erroneous data into the system or unauthorized access to the system.

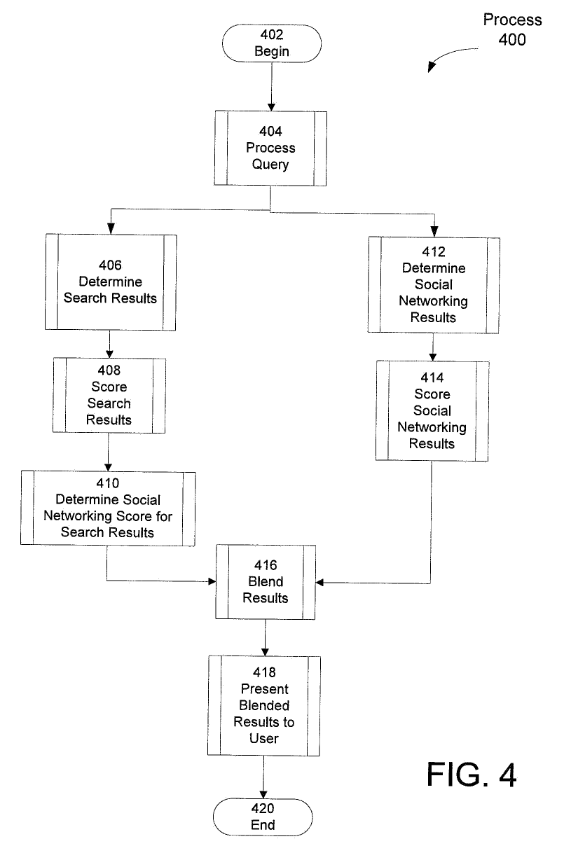

FIG. 4 shows one process 404 for searching a database according to one embodiment of the invention. At block 402, process 400 begins. At block 404, an interface receives and processes a query from a user or other entity. For instance a user may enter within a user interface, one or more keywords associated with a search query. Parameters associated with the search query are forwarded to a search engine (e.g. search engine 208).

At block 406, the search engine determines a set of search results associated with the input query. At block 408, the search engine (e.g., using a scoring engine 318) scores the search results. According to one embodiment, the search engine may include a model of another type of search behavior that can be used to increase the relevancy of search results. For instance, according to one embodiment, a search engine may include a transfer function which is modeled after behavior of a social networking application. To this end, the transfer function may compute a score based on one or more parameters provided to the transfer function. The parameters may be determined from the search results obtained through the query discussed above at block 406. For instance, at block 410, the search engine may determine a social networking score for the search results obtained above at block 406. In one embodiment, the transfer function may determine a bookmarking score associated with one or more parameters determined from the content.

Similarly, a search engine may determine social networking results (e.g., at block 412) associated with the input query. For instance, the query keywords may be passed to a social networking search engine to retrieve bookmarks associated with content that is stored in a social networking database. Further, at block 414, a search engine may compute and return a score specific to the results set determined by the social networking search engine.

At block 416, results determined from the search engine may be combined with results determined from the social bookmarking application. For instance, according to one embodiment, because a social networking score is determined for conventional search results produced by a conventional search engine, the results from the conventional search engine can be presented along with the results produced by the social networking search engine. That is, the transfer function permits the conventional search results to be “scored” in a similar way to the social networking results. According to one embodiment, these results may be blended within a single interface and presented to the user (e.g., at block 418). At block 420, process 400 ends.

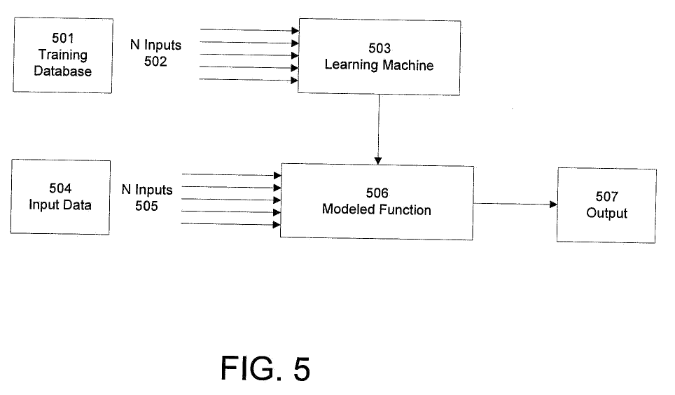

FIG. 5 shows one example system for determining a model of a particular vertical search function. As discussed above, a number of different vertical search functions may be modeled, including, but not limited to, a social networking application. According to one embodiment, a learning machine 503 is provided that accepts N inputs as parameters and produces a modeled function 506. In practice, there are software libraries that model a learning machine which can be trained on a number of inputs. Once trained, the trained software program can accept actual inputs and scores or other classification type can be predicted. According to one embodiment, a number of different parameter types are identified that relate to content (e.g., Internet content) and actual data is provided to learning machine 503 to train the learning machine 503 in order to produce scores for future data.

As discussed above, learning machine 503 may be any entity which is capable of performing a predictive analysis. For instance, regression models, SVTs, neural networks and other constructs may be used to perform predictive analysis according to one embodiment of the invention.

To this end, learning machine 503 is provided a training database 501 which includes a number of content items with their associated parameters and determined scores. For instance, a number of content items may be provided from a social networking database along with their associated scores so that the learning machine 503 may be trained to produce scores that are consistent with the scores determined by the social networking system.

According to one embodiment, the social networking scores are bookmark counts for the content item. That is, assuming the content were referenced within the social bookmarking system, the learning machine 503 determines what score would be attributed to the particular content item if it were indeed tracked within the social bookmarking system. Although in this example bookmark counts may be used as a score, it should be appreciated that any other parameter indicative of relevance may be used to score a content item.

In one embodiment, the parameter values (“x” values) are derived from a conventional search engine. The parameters may be chosen which correlate to a bookmark count in the social bookmarking system. For example, features measured by the search engine such as recency, blogginess, spamminess, etc. are collected. These parameters are generally in the form of scores which are used by a scoring engine associated with a conventional search engine to order a set of search results. The “y” values in this case would be the indication of relevancy as measured by the social networking system for the particular content (e.g., the bookmark count). Data points for content where both the “x” values and “y” values are known are collected, and are used to train the learning machine. Thus, the correlation between the input values for the conventional search engine based on the content, and the output relevancy (the bookmark count) may be determined.

After the learning machine 503 has been trained, the system may be capable of producing scores for one or more input data items. For example, a search engine (e.g., search engine 208) including learning machine 503 may be able to accept one or more input data items 504 having N parameters 505 that can be scored. For instance, in the case of a search engine, a number of results based on a query may be provided as input to modeled function 506, and output scores 507 may be determined for each of the query results. Thereafter, the order by which the original query results are ranked may be reranked based on the computed scores. Further, as discussed above, these results may be combined with results produced by the social networking search engine by order of the computed score (e.g., the bookmarking count).

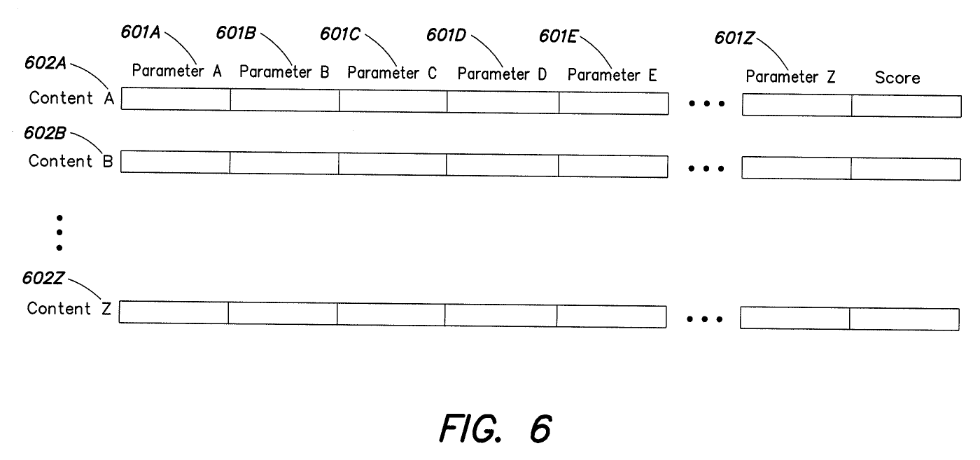

FIG. 6 shows one example of a training database 501 which may be used to train a learning machine (e.g., learning machine 503). A training database may include one or more entries associated with one or more content items (e.g., content items A-Z (elements 602A-602Z)). Each of the content items may include one or more parameters (e.g., parameters A-Z (elements 601A-601Z)). As discussed, these parameters (e.g., these “x” values) may be known and measured by the conventional search engine for each portion of content.

In the case of training, it is beneficial to know, for each element of content in the training set, the associated “y” value, so that the behavior (e.g., as expressed by a transfer function) can be learned. As discussed, according to one embodiment, these “y” values may be relevancy indications as provided by a social bookmarking system. In one example, they may be bookmark counts. The training set, according to one embodiment, may include many entries (e.g., 200K) where both the “x” and “y” values are known. Generally, a learning machine's performance increases as the size of the training set is increased.

Also as discussed, these parameters (or “x” values) may be indicative of a particular attribute of the content or its link. As discussed above, there may be one or more parameters that relates to or is otherwise derive from the content. For instance, there may be one or more link features that relate to the link, its address, the content type, and where the content is located. Other parameters may be related to the content information itself, such as how recent the content is, how “spammy” (or how similar the content is to spam) is the content, how “bloggy” (how similar the content is to a blog) the content is, or other parameter that describes a characteristic of the content. Any number of parameters may be used. However, it is appreciated that the more relevant parameters that are used, the more accurate the learning machine may be with respect to predicting a score associated with the content item.

According to one embodiment, it is appreciated that the number of bookmark counts for particular content items as a distribution where there are several content items that have large numbers of bookmarks, but the majority of content items have one or two bookmarks associated with them. In one embodiment, a log function may be taken of the bookmark count to reduce the score to exponents. For instance, according to one embodiment, the score of a particular content item may be in the range of 0-15. In this manner, because exponents are used, it makes it easier for a learning function to classify a particular content item correctly.

According to another embodiment, rather than using a learning model that produces continuous values, is appreciated that the model may be simplified by using a classification model. More specifically, the learning engine 503 is adapted to classify input content into one of 15 classes associated with the expected number of bookmark counts that the input content should receive. Further, is appreciated that if recency data is omitted as a parameter for the learning engine, then more recent pages which would not be attributed a high bookmark count based on their age will be considered more relevant.

According to one embodiment, it is appreciated that a learning machine that performs regression has difficulty learning the actual values of bookmark scores. According to one embodiment, bookmark scores are discretized when performing the training. Thus, rather than learning the actual bookmark count, a log function of the bookmark count may be used to reduce the range of learning to a set of values from 0 to 15 instead of a range of 0 to 20000. In this way, the reduced range can be trained via classification rather than regression. Further, such a model assists with content features which tend to be more noisy and less accurate for the learned model.

Once trained, the learning model may be used to produce an expected “y” value based on a number of known “x” values. As discussed above, the “x” values may be derived directly by the conventional search engine from the content, so an expected bookmark score (or other indication of relevancy) can be predicted. This model may be incorporated, for example, in a scoring engine associated with a search engine, social bookmarking system, or other system. According to another embodiment, the learning model may be part of a separate system that uses one or more search engines to provide a blended output.

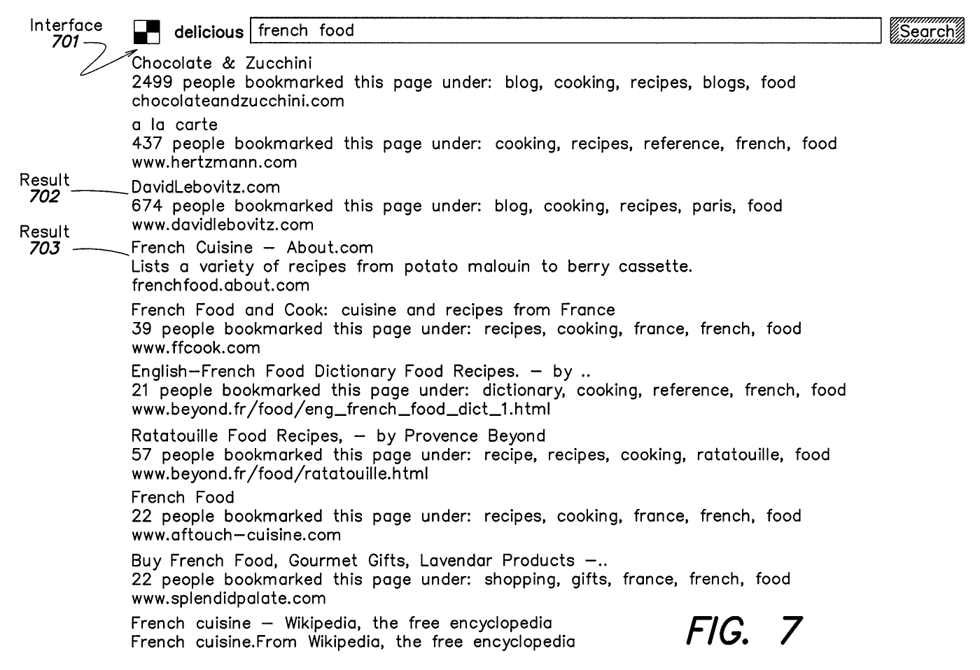

FIG. 7 shows one example interface 701 used to show blended results according to one embodiment of the present invention. For instance, FIG. 7 shows an example interface associated with a social bookmarking application (e.g., del.icio.us) where a social bookmarking result 702 may be displayed along with the result 703 from a conventional search engine. As shown, result 702 includes an actual bookmark score of 674, while result 703 does not have an actual bookmark score, yet is presented with in the same interface as the social bookmarking results. This may be accomplished, for example, by computing an estimated bookmarking score as discussed above, and then ranking the results produced by the conventional search engine along with the results provided by the social bookmarking search engine.

Although a social bookmarking system may be used to produce a model that outputs particular scores, it should be appreciated that any other vertical search system may be used as a model. For instance, other search engine types, other classification engines, or any other system may be modeled.

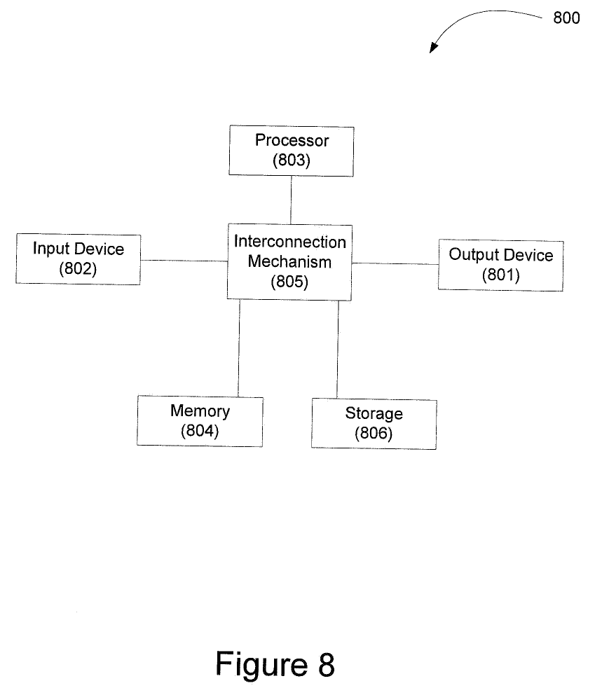

The above defined process 400 according to embodiments of the invention, may be implemented on one or more general-purpose computer systems. For example, various aspects of the invention may be implemented as specialized software executing in a general-purpose computer system 800 such as that shown in FIG. 8. Computer system 800 may include one or more output devices 401, one or more input devices 802, a processor 803 connected to one or more memory devices 804 through an interconnection mechanism 805 and one or more storage devices 806 connected to interconnection mechanism 805. Output devices 801 typically render information for external presentation and examples include a monitor and a printer. Input devices 802 typically accept information from external sources and examples include a keyboard and a mouse. Processor 803 typically performs a series of instructions resulting in data manipulation. Processor 803 is typically a commercially available processor such as an Intel Pentium, Motorola PowerPC, SGI MIPS, Sun UltraSPARC, or Hewlett-Packard PA-RISC processor, but may be any type of processor. Memory devices 804, such as a disk drive, memory, or other device for storing data is typically used for storing programs and data during operation of the computer system 800. Devices in computer system 800 may be coupled by at least one interconnection mechanism 805, which may include, for example, one or more communication elements (e.g., busses) that communicate data within system 800.

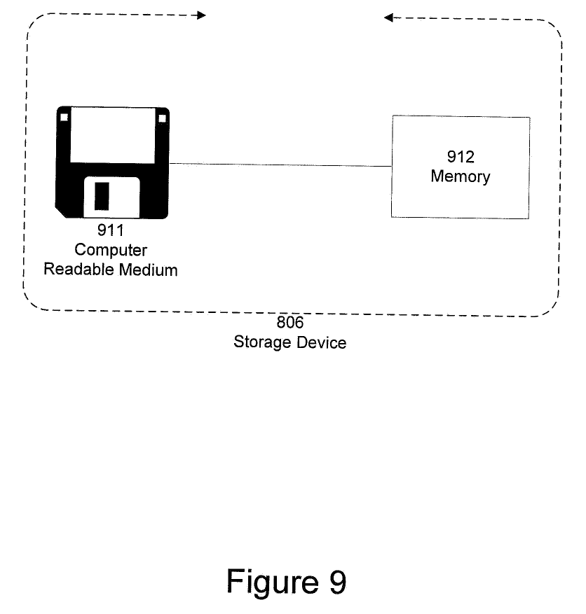

The storage device 806, shown in greater detail in FIG. 9, typically includes a computer readable and writeable nonvolatile recording medium 911 in which signals are stored that define a program to be executed by the processor or information stored on or in the medium 911 to be processed by the program. The medium may, for example, be a disk or flash memory. Typically, in operation, the processor causes data to be read from the nonvolatile recording medium 911 into another memory 912 that allows for faster access to the information by the processor than does the medium 911. This memory 912 is typically a volatile, random access memory such as a dynamic random access memory (DRAM), static memory (SRAM). Memory 912 may be located in storage device 806, as shown, or in memory device 804. The processor 803 generally manipulates the data within the memory 804, 912 and then copies the data to the medium 911 after processing is completed. A variety of mechanisms are known for managing data movement between the medium 911 and the memory 804, 912, and the invention is not limited thereto. The invention is not limited to a particular memory device 804 or storage device 806.

Computer system 800 may be implemented using specially programmed, special purpose hardware, or may be a general-purpose computer system that is programmable using a high-level computer programming language. For example, computer system 800 may include cellular phones, personal digital assistants and/or other types of mobile computing devices. Computer system 800 usually executes an operating system which may be, for example, the Windows 95, Windows 98, Windows NT, Windows 2000, Windows ME, Windows XP, Windows Vista or other operating systems available from the Microsoft Corporation, MAC OS System X available from Apple Computer, the Solaris Operating System available from Sun Microsystems, or UNIX operating systems available from various sources (e.g., Linux). Many other operating systems may be used, and the invention is not limited to any particular implementation. For example, an embodiment of the present invention may build a text analytics database using a general-purpose computer system with a Sun UltraSPARC processor running the Solaris operating system.

Although computer system 800 is shown by way of example as one type of computer system upon which various aspects of the invention may be practiced, it should be appreciated that the invention is not limited to being implemented on the computer system as shown in FIG. 8. Various aspects of the invention may be practiced on one or more computers having a different architecture or components than that shown in FIG. 8. To illustrate, one embodiment of the present invention may receive search criteria using several general-purpose computer systems running MAC OS System X with Motorola PowerPC processors and several specialized computer systems running proprietary hardware and operating systems.

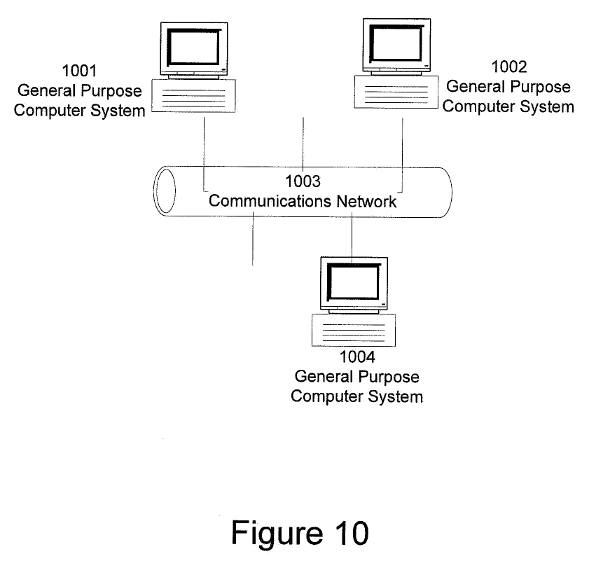

As depicted in FIG. 10, one or more portions of the system may be distributed to one or more computers (e.g., systems 1001, 1002, 1004) coupled to communications network 1003. These computer systems 1001, 1002, 1004 may also be general-purpose computer systems. For example, various aspects of the invention may be distributed among one or more computer systems configured to provide a service (e.g., servers) to one or more client computers, or to perform an overall task as part of a distributed system. More particularly, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP). To illustrate, one embodiment may expert search engine results though a browser interpreting HTML forms and may store document information in a document database using a data translation service running on a separate server.

Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof. For example, a meaning taxonomy user interface may be implemented using a Microsoft Excel spreadsheet while the application designed to tagged documents associated with meaning loaded entities may be written in C++.

It should be appreciated that a general-purpose computer system in accord with the present invention may perform functions outside the scope of the invention. For instance, aspects of the system may be implemented using an existing commercial product, such as, for example, Database Management Systems such as SQL Server available from Microsoft of Seattle Wash., Oracle Database from Oracle of Redwood Shores, Calif., and MySQL from MySQL AB of UPPSALA, Sweden and WebSphere middleware from IBM of Armonk, N.Y. If SQL Server is installed on a general-purpose computer system to implement an embodiment of the present invention, the same general-purpose computer system may be able to support databases for sundry applications.

Based on the foregoing disclosure, it should be apparent to one of ordinary skill in the art that the invention is not limited to a particular computer system platform, processor, operating system, network, or communication protocol. Also, it should be apparent that the present invention is not limited to a specific architecture or programming language.

Having now described some illustrative aspects of the invention, it should be apparent to those skilled in the art that the foregoing is merely illustrative and not limiting, having been presented by way of example only. While the bulk of this disclosure is focused on embodiments directed to social networking systems, aspects of the present invention may be applied to other information domains, for instance, other vertical search functions that are provided in the Internet environment. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

What is claimed is:

1. A computer-implemented method for searching information, the method comprising acts of:
providing for an interface to accept a query to search one or more database entries;
performing, by a search engine, the query on the one or more database entries;
retrieving a plurality of results, the plurality of results including at least two result entries;
providing a model of a social networking ranking function;
determining a social networking ranking of the at least two result entries using the model of the social networking ranking function;
performing, by a social networking system search engine, the query on a social networking database, and retrieving at least one result, the at least one result including an associated social networking ranking; and
presenting, in order of social networking ranking, the at least two result entries with the at least one result, within a single interface to a user.

2. The method according to claim 1, wherein the social networking ranking includes a bookmark score.

3. The method according to claim 2, wherein the bookmark score indicates a number of times a particular content item was bookmarked in the social networking database.

4. The method according to claim 1, further comprising an act of determining a transfer function that models a ranking behavior of a social networking ranking function.

5. The method according to claim 4, wherein the social networking ranking function produces a bookmarking score.

6. The method according to claim 1, further comprising an act of indicating a preference for search results produced by the social networking system search engine.

7. The method according to claim 6, further comprising an act of indicating the preference by a preferred order of entries within the single interface.

8. The method according to claim 1, further comprising an act of providing a plurality of parameters associated with the at least two result entries to the model of the social networking ranking function.

9. The method according to claim 8, further comprising an act of producing, by the model of the social networking ranking function, respective scores indicating a relevancy of the respective at least two result entries.

10. The method according to claim 9, wherein the respective scores are predicted bookmark counts of the respective at least two result entries.

11. The method according to claim 8, wherein the plurality of parameters are determined by the search engine.

12. The method according to claim 8, wherein the plurality of parameters are determined for content referred to by the database entries.

13. A distributed computer system adapted to perform a search query, the distributed computer system comprising:
an interface adapted to accept search criteria;
a search engine adapted to produce a first set of search results based on the search criteria;
a scoring engine adapted to score the first set of search results, the scoring engine being trained to score search results based on a set of parameters;
a social networking search engine adapted to perform a query based on the search criteria on a social networking database, and retrieving at least one result, the at least one result including an associated social networking ranking; and
an interface adapted to present, in order of a social networking ranking, the first set of search results and the at least one result, within a single interface to a user.

14. The computer system according to claim 13, wherein the social networking ranking includes a bookmark score.

15. The computer system according to claim 14, wherein the bookmark score indicates a number of times a particular content item was bookmarked in the social networking database.

16. The computer system according to claim 13, further comprising a component adapted to determine a transfer function that models a ranking behavior of a social networking ranking function.

17. The computer system according to claim 16, wherein the social networking ranking function is adapted to produce a bookmarking score.

18. The computer system according to claim 13, wherein the interface is adapted to indicate a preference for search results produced by the social networking system search engine.

19. The computer system according to claim 18, wherein the interface is adapted to indicate the preference by a preferred order of entries within the interface.

20. The computer system according to claim 13, wherein the search engine is adapted to provide a plurality of parameters associated with the at least two result entries to the model of the social networking ranking function.

21. The computer system according to claim 20, wherein the model of the social networking ranking function is adapted to determine respective scores indicating a relevancy of the respective at least two result entries.

22. The computer system according to claim 21, wherein the respective scores are predicted bookmark counts of the respective at least two result entries.

23. The computer system according to claim 20, wherein the plurality of parameters are determined by the search engine.

24. The computer system according to claim 20, wherein the plurality of parameters are determined for content referred to by the database entries.

25. A distributed computer system adapted to perform a search query, the distributed computer system comprising:
an interface adapted to accept search criteria;
a first search engine adapted to produce a first set of search results based on the search criteria, the first set of search results having a first ranking;
a second search engine adapted to produce a second set of search results based on the search criteria, the second set of search results having a second ranking;
a model of a ranking behavior of the second search engine;
a component that normalizes the ranking behavior of the second search engine to a ranking behavior of the first search engine;
a component adapted to determine a combined ranking of the first set of search results and the second set of search result; and
an interface adapted to present the combined ranking to at least one of a computer system and a user.

26. The computer system according to claim 25, wherein the model of the ranking behavior of the second search engine is used to determine an estimated bookmark count of content.
